(19) United States
(12) Patent Application Publication
(10) Pub. No.: US 2009/0307131 A1
(43) Pub. Date: Dec. 10, 2009

(54) Payment and settlement over the internet with internet currencies

(76) Inventor: Hong Liu, Forest Hills, NY (US)

Correspondence Address: Hong Liu, Apartment 2E, 67-30 Dartmouth Street, Forest Hills, NY, 11375, US

(21) Appl. No.: 12/157,056

(22) Filed: Jun. 6, 2008

(51) Int. Cl. G06Q 20/00; G06Q 40/00

(52) U.S. Cl. 705/41; 705/35

(57) ABSTRACT

A method of payment and settlement over the Internet with Internet Currencies for purchases of products and services or their equivalents over the Internet, it can be used for payment and settlement over the Internet for other purposes as well. It is secure, convenient and flexible for every consumer and therefore can greatly increase the Internet business.

### BACKGROUND OF THE INVENTION

This invention pertains to the field of payments and other settlements over the Internet, for purchases of products, services and/or their equivalents over the Internet, and more particularly, to a convenient, flexible and secure method for payments and settlements over the internet.

Internet purchases and services have gotten more and more popular these years, but there are issues concerning payments and settlements that affecting its growth. Traditionally, there are three major methods to pay for the purchase and services over the Internet: by credit card, by money order or check and by remittance. The disadvantages of payment by credit card are that, there are people who don't have a credit card, and there are people who don't want to use their credit card for Internet purchase and services because of the Internet theft and fraud. The disadvantages of payment by money order or check are that, they are not convenient and taking longer time to process. The disadvantages of payment by remittance are that, some people don't have a banking account, and remittance is not very convenient and time consuming as well.

### SUMMARY OF THE INVENTION

It is therefore an object of this invention to provide an improved, more convenient, flexible and secure method of payment and settlements for purchases of products, services, and/or their equivalents over the Internet. By using Internet Currencies issued and retailed by Banks, other financial Institutions, Post Office and their equivalents, it eliminates the limitations of traditional payment methods, making the payment and settlement more convenient, flexible and secure for everyone, maximizes the protection and minimizes the risks of consumers and customers for payment and settlement over the internet.

### DETAILED DESCRIPTION OF THE INVENTION

Payments and Settlements over the Internet being made with Internet Currencies, which are in the forms of cash cards, and/or cash coupons, and/or cash notes or their equivalents, prepaid, with predetermined amount and/or with amount being deposited into. The Internet Currencies are with preprinted and covered numbers, and/or passwords, and/or codes or their equivalents, that can be shown after the cover being scratched off by consumers and customers after their purchasing of the Internet Currencies, for the purpose of verification and authentication over the internet while the Internet Currencies being used for payment and settlement.

The Internet Currencies could be issued by Banks, Other Financial Institutions, Post Offices, or their equivalents. Those entities are well trusted so the Internet Currencies issued by them can be widely distributed and used for payments and settlements for all kinds of purchases and Services or their equivalents over the Internet. The Internet Currencies could be retailed by the above mentioned entities, their equivalents and/or their agents, associates and franchisees.

By using the Internet Currencies, everyone can make payments and do settlement arrangements over the Internet, whether with or without a banking account, whether with or without a credit card. This makes Internet purchases, payments and settlements very convenient and easy for all consumers and can greatly increase the business over the Internet.

By using the Internet Currencies for payment and settlements over the Internet, it can maximize the protection and minimize the risks of customers and consumers involved in Internet purchase, payments and settlements. As even if there is an Internet theft and fraud, no further harms and affects can be done to the consumers as no personal and private banking and credit card information could be released from the payment and purchase made.

I claim:

1. A method of payment and settlements over the Internet, with Internet Currencies or the like.

2. An internet payment and settlement vehicle(s) being called Internet Currencies in this invention, including:
(a) Cash card or its equivalents, being prepaid, with predetermined amount and/or with amount being deposited into. The card or its equivalents being with preprinted and covered numbers, and/or passwords, and/or codes or their equivalents, that can be shown after the cover being scratched off by consumers and customers after their purchasing, for the purpose of verification and authentication of the cards or their equivalents over the internet while being used for payment and settlement; and
(b) Cash coupon or its equivalents, being prepaid, with predetermined amount and/or with amount being deposited into. The coupon or its equivalents being with preprinted and covered numbers, and/or passwords, and/or codes or their equivalents, that can be shown after the cover being scratched off by consumers and customers after their purchasing, for the purpose of verification and authentication of the coupons or their equivalents over the internet while being used for payment and settlement; and
(c) Cash note or its equivalents, being prepaid, with predetermined amount and/or with amount being deposited into. The card or its equivalents being with preprinted and covered numbers, and/or passwords, and/or codes or their equivalents, that can be shown after the cover being scratched off by consumers and customers after their purchasing, for the purpose of verification and authentication of the notes or their equivalents over the internet while being used for payment and settlement.

3. The Internet Currencies as claimed in claim 2, said Internet Currencies could be issued by Banks and their equivalents.

4. The Internet Currencies as claimed in claim 2, said Internet Currencies could be issued by other financial companies, institutions and their equivalents.

5. The Internet Currencies as claimed in claim 2, said Internet Currencies could be issued by Post Office and its equivalents.
